(19) United States
(12) Patent Application Publication
(10) Pub. No.: US 2026/0356705 A1
(43) Pub. Date: Nov. 12, 2026

(54) SCALE REMOVAL SYSTEM

(71) Applicant: KMX Co., Ltd., Ulsan (KR)

(72) Inventors: Sung Gyu KIM, Uljin-gun (KR); Su Chan YANG, Paju-si (KR)

(21) Appl. No.: 19/660,093

(22) Filed: Apr. 27, 2026

(30) Foreign Application Priority Data
May 12, 2025 (KR) 10-2025-0061349

(51) Int. Cl. C02F 1/463; C02F 1/38

(52) U.S. Cl. CPC C02F 1/463; C02F 1/385; C02F 2201/007; C02F 2201/46135; C02F 2303/22

(57) ABSTRACT

Provided is a scale removal system. Herein, a scale precipitation device for precipitating scale from water to be treated supplied from outside using an electrochemical reaction to provide primary treated water; and a hydrocyclone device connected to the scale precipitation device and configured to precipitate scale or non-conductive foreign substances flowing in from the primary treated water supplied from the scale precipitation device without being removed therein to provide purified water; are included, thereby disclosing technology capable of improving management efficiency for a circulating cooling system including a cooling tower or heat exchanger while reducing management costs.

### BACKGROUND OF THE INVENTION

### Field of the Invention

The present invention relates to a scale removal system, and more particularly, to a scale removal system applicable to a circulating cooling water system equipped with a cooling tower and a heat exchanger, which is capable of removing scale or foreign substances contained in cooling water.

### Description of the Related Art

Heat exchange equipment for cooling heat-exchanging objects such as mechanical devices is installed in a wide range of fields, including factories and large buildings. Cooling water whose temperature has risen due to heat exchange dissipates heat by coming into contact with air in a cooling tower, and the cooling water, whose temperature has been lowered by the latent heat of vaporization of water, is repeatedly circulated back to the heat exchanger, thereby forming a cooling water system.

At this time, since part of the cooling water is scattered along with evaporation from the cooling tower and discharged outside the cooling water system, industrial water or groundwater is utilized in the circulating cooling water system. Since industrial water (groundwater) is hard water containing relatively large amounts of calcium ions and magnesium ions, hardness components in the makeup water accumulate in the circulating cooling water system, causing the concentration of hardness components to gradually increase, and inducing scale problems on the heat transfer surfaces of cooling tower heat exchangers or inside piping.

Such scale not only obstructs the flow of cooling water but also reduces thermal efficiency, resulting in wasted energy. Accordingly, in order to use cooling water in cooling equipment, boilers, and the like, it is necessary to remove such components. Thus, conventionally, a scale component removal device has been used to remove scale from cooling water before supplying it to cooling equipment.

A conventional scale removal device includes a reactor having a negative polarity, a plate body installed inside the reactor and having a positive polarity, a power supply unit for applying current to each of the reactor and the plate body, and a scaling discharge pipe.

When cooling water is introduced into the reactor and current is applied to the reactor and the plate body installed inside the reactor, the reactor becomes a cathode and the plate body becomes an anode. As the reactor and the plate body become the cathode and anode respectively, the cooling water inside the reactor undergoes electrolytic reaction. At this time, calcium, magnesium, silicon, and the like contained in the cooling water react with hydroxide ions (OH⁻) generated at the cathode to produce calcium carbonate (CaCO₃), magnesium hydroxide (Mg(OH)₂), and silicon dioxide (SiO₂).

The produced calcium carbonate, magnesium hydroxide, silicon dioxide, and the like react with calcium ions in the cooling water to generate calcium carbonate, which is then precipitated as scale in the form adhered to the reactor. When scale is precipitated in excess of a certain amount, it is separated from the reactor and discharged through a scaling discharge pipe provided on one side of the reactor.

Such a conventional scale removal device has limitations in removing scale of a fine size, and fine-sized scale flows into the heat exchanger system through the cooling tower as it is, requiring periodic overall cleaning or replacement of related parts such as saren tubes.

Therefore, there is a need for a technology that can also remove fine-sized scale to extend the interval between overall cleanings, extend the replacement cycle of related parts such as saren tubes, or make replacement unnecessary.

Furthermore, there has been a demand for the development of technology capable of removing not only scale but also non-conductive foreign substances that are difficult to remove by electrochemical reactions.

### RELATED ART DOCUMENTS

(Patent Document 1) Korean Registered Patent Publication No. 10-1787649

### SUMMARY OF THE INVENTION

An object of the present invention is to solve the conventional problems described above, and to provide a scale removal system capable of removing not only scale contained in circulating cooling water but also non-conductive foreign substances.

A scale removal system according to an embodiment of the present invention for achieving the above object may comprise: a scale precipitation device for precipitating scale from water to be treated supplied from the outside using an electrochemical reaction to provide primary treated water; and a hydrocyclone device connected to the scale precipitation device, for precipitating scale or non-conductive foreign substances flowing in from the primary treated water without being removed in the scale precipitation device, thereby providing purified water.

The system may further comprise a strainer connected communicably to the other end of the scale precipitation device or the other end of the hydrocyclone device, and configured to receive and accommodate therein the scale or the foreign substances from the scale precipitation device or the hydrocyclone device.

The scale precipitation device may comprise: a reaction tank provided with a water supply port through which water to be treated is introduced, and providing a space where an electrochemical reaction for precipitating the scale from the water to be treated introduced into the reaction tank takes place; a first electrode body disposed in the reaction tank; a second electrode body disposed in the reaction tank; and a discharge tank disposed below the reaction tank and having a conical shape with a diameter that decreases toward the lower side. Voltage is applied to the first electrode body or the second electrode body to precipitate the scale by the electrochemical reaction.

The first electrode body or the second electrode body may comprise a cylindrical mesh net.

The hydrocyclone device may comprise: a cyclone body providing a space in which the primary treated water supplied from the scale precipitation device forms a cyclonic flow; a reducer provided below the cyclone body and forming an internal space communicating with the cyclone body, the reducer having a conical shape with a diameter that decreases toward the lower side, and provided with a discharge port at the lower end; and a collection pipe disposed below the cyclone body, containing at least a portion of the reducer therein, and configured to receive the scale or the foreign substances through the discharge port of the reducer.

The hydrocyclone device may be provided with a return means for returning a portion of the water introduced into the collection pipe back to the inside of the cyclone body or the reducer.

### BRIEF DESCRIPTION OF THE DRAWINGS

FIG. 1 is a perspective view schematically illustrating a scale removal system according to an embodiment of the present invention.

FIG. 2 is a front view schematically illustrating a scale removal system according to an embodiment of the present invention.

FIG. 3 is a cross-sectional view schematically illustrating a portion of the scale removal system according to an embodiment of the present invention.

FIG. 4 is a partial cross-sectional perspective view schematically illustrating a portion of the scale removal system according to an embodiment of the present invention.

### DETAILED DESCRIPTION OF THE EMBODIMENTS

Hereinafter, the present invention will be described in more details.

The present invention is capable of various modifications and may have various embodiments. Specific embodiments will be illustrated in the drawings and described in detail. However, this is not intended to limit the present invention to a specific embodiment, and it should be understood to include all modifications, equivalents, and substitutes included in the spirit and technical scope of the present invention. These embodiments are provided to more fully describe the present invention to those skilled in the art. Therefore, the shapes of each element shown in the drawings may be exaggerated for a clearer description, and in describing the present invention, a detailed description of related known technologies may be omitted if it is determined that it may obscure the gist of the present invention.

Terms such as “first” and “second” may be used to describe various components, but the components should not be limited by the terms. These terms are used for the purpose of distinguishing and understanding one component from another component.

Terms used in the present invention are used only to describe specific embodiments and are not intended to limit the present invention. Singular expressions include plural expressions unless the context clearly dictates otherwise.

In the present invention, terms such as “comprise” or “have” are intended to specify the presence of features, numbers, steps, operations, components, parts, or combinations thereof described in the specification, and are to be understood as not precluding the possibility of the presence or addition of one or more other features, numbers, steps, operations, components, parts, or combinations thereof.

Hereinafter, embodiments of the present invention will be described in detail with reference to the accompanying drawings so that those skilled in the art to which the present invention pertains can easily implement the present invention. However, the present invention may be implemented in various different forms and is not limited to the embodiments described herein. Similar reference numerals may be used for similar parts throughout the specification.

Hereinafter, a scale removal system according to an embodiment of the present invention will be described with reference to the drawings.

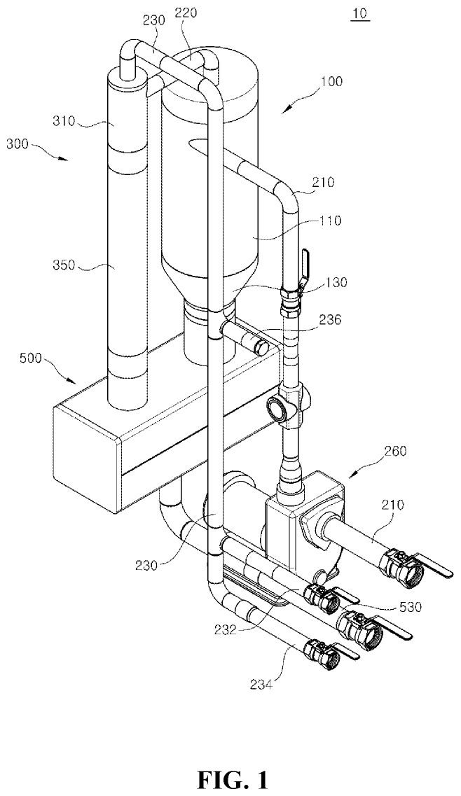

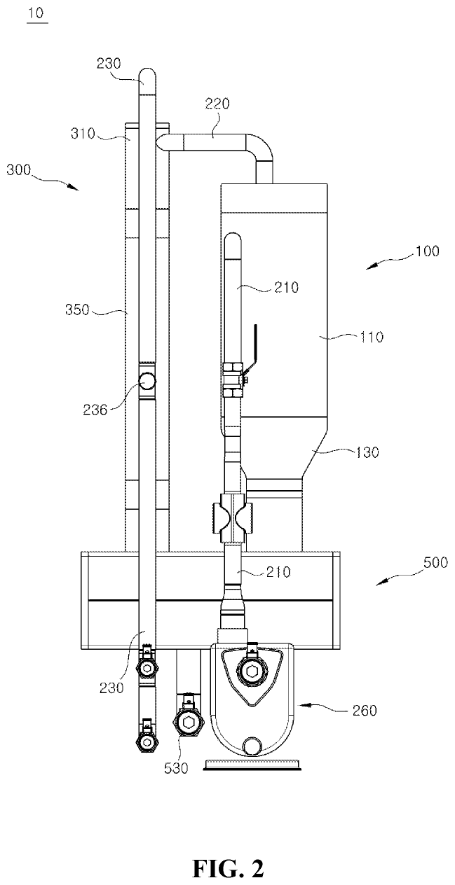

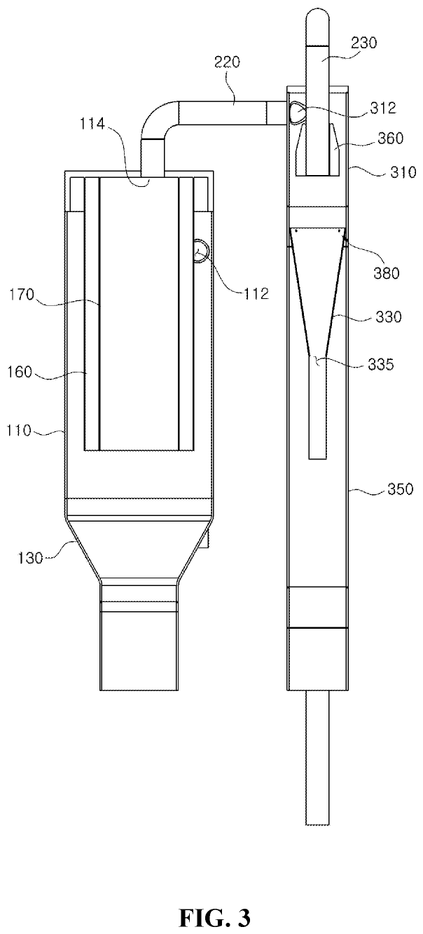

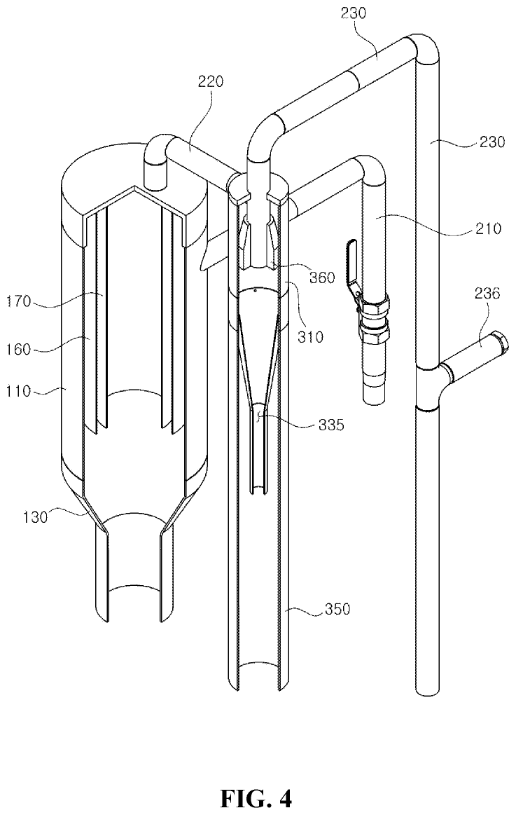

FIG. 1 is a perspective view schematically illustrating a scale removal system according to an embodiment of the present invention, and FIG. 2 is a front view schematically illustrating a scale removal system according to an embodiment of the present invention. FIG. 3 is a rear cross-sectional view schematically illustrating the scale precipitation device and hydrocyclone device portions of the scale removal system according to an embodiment of the present invention, and FIG. 4 is a partial cross-sectional perspective view schematically illustrating the scale precipitation device and hydrocyclone device portions of the scale removal system according to an embodiment of the present invention.

Referring to FIGS. 1 to 4, a scale removal system 10 according to an embodiment of the present invention comprises a scale precipitation device 100 and a hydrocyclone device 300. More preferably, it may further comprise a strainer 500.

The scale precipitation device 100 precipitates scale from water to be treated supplied from outside using an electrochemical reaction to provide primary treated water. That is, circulating cooling water from a cooling tower or heat exchanger is supplied as water to be treated to the scale precipitation device 100 through a water supply pipe 210.

The water to be treated supplied to the scale precipitation device 100 becomes primary treated water from which scale has been precipitated by the electrochemical reaction, and is transferred to the hydrocyclone device 300. Since the electrochemical reaction itself for precipitating scale is widely known, a detailed description thereof will be omitted.

The scale precipitation device 100 and the hydrocyclone device 300 are connected through a transfer pipe 220 so that the primary treated water can be transferred from the scale precipitation device 100. The primary treated water, with scale or non-conductive foreign substances removed in the hydrocyclone device 300, becomes purified water and is returned to the cooling tower or heat exchanger side.

First, describing the scale precipitation device 100 in more detail, the scale precipitation device 100 in the scale removal system 10 according to the present invention comprises a reaction tank 110, a first electrode body 160, a second electrode body 170, and a discharge tank 130, and voltage is applied to the first electrode body 160 or the second electrode body 170 to precipitate scale from the water to be treated by the electrochemical reaction.

The reaction tank 110 is provided with a water supply port 112 through which water to be treated is introduced. Here, the water supply port 112 is connected to a water supply pipe 210 connected to the cooling tower or heat exchanger side. The water supply pipe 210 may be provided with a pump 260 so that water to be treated can be supplied to the reaction tank 110. Accordingly, water to be treated supplied through the water supply pipe 210 is introduced into the reaction tank 110 through the water supply port 112. The reaction tank 110 provides a space where the electrochemical reaction for precipitating scale from the introduced water to be treated takes place.

As referenced in the drawings, the water supply port 112 is connected not in the direction toward the central axis of the reaction tank 110 but in the tangential direction of the reaction tank 110. Accordingly, the water to be treated introduced eccentrically into the reaction tank 110 through the water supply port 112 forms a cyclonic flow within the reaction tank 110. Such a cyclonic flow helps promote the reaction for removing hardness components.

Primary treated water with relatively fewer hardness components is present at the center of the reaction tank 110. This primary treated water is moved to the transfer pipe 220 through a water delivery port 114 provided on the upper side of the reaction tank 110 and located on the central axis of the reaction tank 110.

The first electrode body 160 and the second electrode body 170 are disposed in the reaction tank 110 and receive applied voltage so that the electrochemical reaction for precipitating scale from the water to be treated can take place within the reaction tank 110.

The materials of the first electrode body 160 and the second electrode body 170 may be made of conductive materials. For example, platinum, copper, nickel, aluminum, iron, molybdenum, chromium, titanium, carbon steel, stainless steel, and the like may be used as materials.

The first electrode body 160 and the second electrode body 170 preferably comprise portions formed in a cylindrical shape as referenced in the drawings. More specifically, the first electrode body 160 and the second electrode body 170 are preferably formed to comprise a cylindrical mesh net.

It is preferable that the cylindrical first electrode body 160 and second electrode body 170 are disposed within the reaction tank 110 such that the central axes of the reaction tank 110, the first electrode body 160, and the second electrode body 170 coincide.

By applying voltage to the first electrode body 160 and the second electrode body 170 arranged in this manner, scale can be precipitated from the water to be treated.

To this end, a controller that receives power from outside and applies voltage to the first electrode body 160 and the second electrode body 170 may be further provided. Although omitted in the drawings, the controller may be connected to the terminals of the first electrode body 160 and the second electrode body 170 exposed to the outside of the reaction tank 110 to apply voltage.

A positive DC voltage or a negative DC voltage may be applied to each of the first electrode body 160 and the second electrode body 170. The efficiency of scale precipitation can be improved by changing the polarity of the applied voltage at regular intervals.

Accordingly, the controller for applying voltage to the first electrode body 160 and the second electrode body 170 can alternately apply a positive DC voltage and a negative DC voltage to the first electrode body 160 and the second electrode body 170 at predetermined time intervals.

The discharge tank 130 is disposed below the reaction tank 110 and has a conical shape with a diameter that decreases toward the lower side. Scale precipitated from the water to be treated adheres to the first electrode body 160 or the second electrode body 170.

When a negative DC voltage is applied to the electrode body, the precipitated scale adheres to the electrode body. When a positive DC voltage is applied to the electrode body, the scale adhering to the electrode body falls off.

As the polarity of the voltage applied to the first electrode body 160 and the second electrode body 170 alternates, the scale falls off from the first electrode body 160 or the second electrode body 170 and settles toward the lower side of the discharge tank 130.

As the scale precipitated from the water to be treated settles and collects toward the lower side of the discharge tank 130, the primary treated water is moved out to the transfer pipe 220 through the water delivery port provided on the upper side of the reaction tank 110.

The primary treated water moving along the transfer pipe 220 moves into the cyclone body 310 of the hydrocyclone device 300. The hydrocyclone device 300 precipitates scale or non-conductive foreign substances contained in the primary treated water without being removed in the scale precipitation device 100, thereby forming purified water. The purified water obtained from the hydrocyclone device 300 is again delivered to the cooling tower or heat exchanger side.

The hydrocyclone device 300 comprises a cyclone body 310, a reducer 330, and a collection pipe 350.

The cyclone body 310 provides a space in which the primary treated water supplied from the scale precipitation device 100 forms a cyclonic flow. The cyclone body 310 has a cylindrical shape.

The primary treated water introduced eccentrically into the cyclone body 310 forms a cyclonic flow and moves to the reducer 330 provided below the cyclone body 310.

The reducer 330 is provided below the cyclone body 310 and forms an internal space communicating with the cyclone body 310, having a conical shape with a diameter that decreases toward the lower side. The lower end of the reducer 330 is provided with a discharge port.

Since the reducer 330 has a conical shape with a diameter that decreases toward the lower side, the primary treated water that formed a cyclonic flow in the cyclone body 310 forms an increasingly faster cyclonic flow toward the lower side of the reducer 330. At this time, scale and non-conductive foreign substances are removed from the primary treated water, resulting in purified water. The purified water moves upward in the cyclone body 310.

A water outlet pipe 230 through which the primary treated water, with scale or non-conductive foreign substances removed, exits as purified water is connected to the upper side of the cyclone body 310. Accordingly, the purified water coming out through the water outlet pipe 230 can be supplied again to the cooling tower or heat exchanger side. For reference, the scale removed here refers to scale that mixed with the primary treated water without being removed in the scale precipitation device 100 and was introduced together into the hydrocyclone device 300.

A foreign substance discharge port 335 through which scale and foreign substances can be discharged is provided at the lower end of the reducer 330.

In the hydrocyclone device 300, assuming the amount of water introduced into the cyclone body 310 through the transfer pipe 220 is 100, and the amount of purified water exiting as output through the water outlet pipe 230 is 40, the amount of water flowing out through the foreign substance discharge port 335 at the lower end of the reducer 330 would be 60. If 60 units of water continue to be discarded through the foreign substance discharge port 335 while the hydrocyclone device 300 continues to operate, the amount of water wasted would be too large.

Therefore, in the present invention, the collection pipe 350 is provided below the cyclone body 310 to ensure a certain level of purification performance while reducing the amount of water wasted during operation of the hydrocyclone device 300.

The collection pipe 350 is disposed below the cyclone body 310, internally accommodates at least a portion of the reducer 330 within its internal space, and receives scale or foreign substances through the discharge port of the reducer 330. Furthermore, the collection pipe 350 also receives water coming out through the discharge port of the reducer 330.

Scale and foreign substances discharged through the foreign substance discharge port 335 provided at the lower end of the reducer 330 settle and descend within the collection pipe 350. Accordingly, foreign substances and scale accumulate in the collection pipe 350, and they can be removed through periodic cleaning maintenance.

During operation of the hydrocyclone device 300, the lower side of the collection pipe 350 is sealed and water is present inside the collection pipe 350. Here, the hydrocyclone device 300 is preferably provided with a return means for returning a portion of the water introduced into the collection pipe 350 back to the inside of the cyclone body 310 or the reducer 330.

When the collection pipe 350 and the return means for returning a portion of the water introduced into the collection pipe 350 back to the inside of the cyclone body 310 or the reducer 330 are provided, it is possible to suppress the waste of water being continuously discarded through the foreign substance discharge port 335 provided at the lower end of the reducer 330 during operation of the hydrocyclone device 300.

As a preferred example of such a return means, a return port ( [symbol] ) 380 formed at the rim portion of the reducer 330 so as to communicate between the internal space of the collection pipe 350 and the internal space of the reducer 330 may be cited.

Among the water introduced and stored in the collection pipe 350, the water at the upper side is in a relatively cleaner state than the water at the lower side. When the return port 380 is formed at the rim portion of the reducer 330, the water at the upper side within the collection pipe 350 can be returned to the inside of the reducer 330 or the inside of the cyclone body 310 for recirculation. One or more of such return ports 380 may be provided.

Accordingly, it is preferable that purified water can be continuously provided to the outside through the water outlet pipe 230 by continuously purifying the water while suppressing waste of water during operation of the hydrocyclone device 300.

In addition, a tube-shaped return means is also fully possible, having one end connected to the collection pipe 350 and the other end connected to the cyclone body 310, the transfer pipe 220, or the water supply pipe 210 so that a portion of the water in the collection pipe 350 can be returned and circulated, and this is also preferable.

It is also preferable that an acceleration member 360 for accelerating the rotational speed of the primary treated water introduced through the inlet 312 is provided within the cyclone body 310. The transfer pipe 220 is connected in communication with the inlet 312 of the cyclone body 310.

The acceleration member 360 is a member surrounding the water outlet pipe 230 within the cyclone body 310. It narrows the gap between the water outlet pipe 230 and the cylindrical cyclone body 310, allowing water introduced through the inlet 312 to pass through the narrow gap between the acceleration member 360 and the cyclone body 310 while accelerating its rotational speed.

A portion of the acceleration member 360 may have a shape in which the diameter or width increases toward the lower side, so that the speed of the rotating water current accelerates as it rotates downward within the cyclone body 310. As the diameter or width of the acceleration member 360 increases, the gap between the surface of the acceleration member 360 and the inner surface of the cyclone body 310 becomes narrower, thereby accelerating the speed of the rotating water current.

When the primary treated water is introduced into the cyclone body 310 and the rotating speed is accelerated in this manner, it is preferable as it helps in removing scale and non-conductive foreign substances.

The scale removal system 10 comprising the scale precipitation device 100 and the hydrocyclone device 300 as described above may further include the following strainer 500.

As referenced in the drawings, the strainer 500 is connected communicably to the other end of the scale precipitation device 100 or the other end of the hydrocyclone device 300, and receives and accommodates therein scale or non-conductive foreign substances from the scale precipitation device or the hydrocyclone device 300. Accordingly, the strainer 500 is provided with a space therein capable of accommodating scale or non-conductive foreign substances.

In the drawings, a form is illustratively shown in which the strainer 500 is connected communicably to the lower sides of the scale precipitation device 100 and the hydrocyclone device 300. Such a strainer 500 receives and accommodates together scale and foreign substances removed from both sides of the scale precipitation device 100 and the hydrocyclone device 300.

Accordingly, periodic cleaning to remove scale and foreign substances accumulated in the strainer 500 allows the cleaning interval within the scale precipitation device 100 and the hydrocyclone device 300 to be set longer, which can also improve the management efficiency of the scale removal system.

If necessary, a drain pipe 530 capable of draining water inside the strainer 500 to the outside may be provided in the strainer 500, which is also preferable.

The water outlet pipe 230 through which purified water, with scale or foreign substances removed in the hydrocyclone device 300, exits is basically connected 232 to the cooling tower or heat exchanger side to supply purified water. A drain pipe 234 may be provided in the form of a branch pipe from the water outlet pipe 230.

The drain pipe 234 provided in the form of a branch pipe from the water outlet pipe 230 can help manage the quality of the circulating cooling water by periodically discharging a certain amount of water to the outside. To this end, the drain pipe 234 may be provided with a motor-operated valve.

In addition, the water outlet pipe 230 may be provided with a measurement port 236 in the form of a branch pipe that can be connected to a measuring instrument for measuring the electrical conductivity of the purified water to monitor the water quality condition of the purified water. By measuring the electrical conductivity of the purified water, continuous monitoring of the purified water quality is also possible.

Meanwhile, if necessary, as mentioned above, a water supply pump 260 may be provided in the water supply pipe 210 that supplies water to be treated.

As described above, according to the scale removal system according to the embodiment of the present invention, not only scale contained in circulating cooling water but also non-conductive foreign substances can be removed, and since the removal efficiency of scale is improved, there is an advantage in that management efficiency for the circulating cooling system including the cooling tower or heat exchanger can be improved while management costs are reduced.

As described above, specific descriptions of the present invention have been made by the embodiments with reference to the accompanying drawings, but since the above-described embodiments have only described preferred embodiments of the present invention, the present invention should not be understood as being limited to the above embodiments, and the scope of rights of the present invention should be understood by the claims and their equivalents as set forth below.

What is claimed is:

1. A scale removal system comprising:
a scale precipitation device for precipitating scale from the water to be treated supplied from the outside using an electrochemical reaction to provide primary treated water; and
a hydrocyclone device connected to the scale precipitation device, configured to receive the primary treated water supplied from the scale precipitation device, and to precipitate scale or non-conductive foreign substances contained in the primary treated water without being removed in the scale precipitation device, thereby providing purified water.

2. The scale removal system of claim 1, further comprising:
a strainer connected communicably to the other end of the scale precipitation device or the other end of the hydrocyclone device, and configured to receive and accommodate therein the scale or the foreign substances from the scale precipitation device or the hydrocyclone device.

3. The scale removal system of claim 1, wherein the scale precipitation device comprises:
a reaction tank provided with a water supply port through which the water to be treated is introduced, and providing a space where the electrochemical reaction for precipitating the scale from the water to be treated introduced into the reaction tank takes place;
a first electrode body disposed in the reaction tank;
a second electrode body disposed in the reaction tank; and
a discharge tank disposed below the reaction tank and having a conical shape with a diameter that decreases toward the lower side,
wherein voltage is applied to the first electrode body or the second electrode body to precipitate the scale by the electrochemical reaction.

4. The scale removal system of claim 3, wherein the first electrode body or the second electrode body comprises a cylindrical mesh net.

5. The scale removal system of claim 1, wherein the hydrocyclone device comprises:
a cyclone body providing a space in which the primary treated water supplied from the scale precipitation device forms a cyclonic flow;
a reducer provided below the cyclone body and forming an internal space communicating with the cyclone body, the reducer having a conical shape with a diameter that decreases toward the lower side, and provided with a discharge port at a lower end thereof; and
a collection pipe disposed below the cyclone body, containing at least a portion of the reducer therein, and configured to receive the scale or the foreign substances through the discharge port of the reducer.

6. The scale removal system of claim 5, wherein the hydrocyclone device is provided with a return means configured to return a portion of water introduced into the collection pipe back to an inside of the cyclone body or the reducer.
